(19) United States
(12) Patent Application Publication
(10) Pub. No.: US 2021/0228922 A1
(43) Pub. Date: Jul. 29, 2021

(54) COLLAR FOR SAFETY HARNESS FOR THE PROTECTION OF PERSONNEL WORKING AT HEIGHTS, IN CASE OF FALLS

(71) Applicant: Jose Raymundo ITURRIAGA GARCIA, Magdalena Contreras (MX)

(72) Inventor: Jose Raymundo ITURRIAGA GARCIA, Magdalena Contreras (MX)

(21) Appl. No.: 16/943,028

(22) Filed: Jul. 30, 2020

(30) Foreign Application Priority Data
Jan. 23, 2020 (MX) MX/U/2020/000028

(51) Int. Cl. A62B 35/00

(52) U.S. Cl. CPC A62B 35/0025; A62B 35/005; A62B 35/0018

(57) ABSTRACT

A safety harness collar for the protection of personnel working at heights, in the event of falls, consisting of a substantially curved body made up of a plurality of layers of various synthetic or organic materials rolled or inlaid, housed in a containment cover that offers a certain hardness and at the same time a certain flexibility and cushioning which includes at least two fixing means to fix on the straps of a harness that pass through the shoulders of a user and intersect in the front and rear area of the user, to hold on and be arranged around the nape of the neck and sides of the neck to offer support and limit the abrupt movement of the neck towards the back of the user to avoid damage to the cervical vertebrae and even the death of the user in the event of a fall.

### FIELD OF THE INVENTION

the present invention is related to safety devices and mechanisms, of the type that act on a belt, cable or the like that have the purpose of absorbing a fall. More specifically, it refers to a safely harness collar for the protection of personnel working at heights in the event of falls.

### BACKGROUND OF THE INVENTION

Currently, in the field of construction and other activities that require work at heights, it is necessary to use safety devices and mechanisms that protect the worker from accidents when falling, causing serious injuries or even death. The fall protection devices or systems consist of a full body harness and rings attached to the harness in specific zones such as back or side, lifelines and connector to anchor point; damping systems may also be included.

Said fall arrest systems are designed and configured to decrease the braking force so that the user or worker does not get hurt. However, when a person connects from the front ring, of a harness to an anchor and suffers a fall, the harness is not adapted to protect the head, in the nape area, so the worker can injure his head when receiving whiplash from falling, which can lead to severe injury or even death.

Currently there are devices similar to the present invention, hut with different applications. For example, there are motorcycle collars that adapt to the helmet and prevent the helmet from moving backwards in the event of an impact, avoiding whiplash on the head. However, these devices can only be used when using the motorcycle helmet, it could not be coupled with a harness for a height worker.

A search was carried out to determine the closest state of the art, finding the following information:

U.S. Pat. No. 7,846,117 to Christopher James Leatt, et al. of Dec. 7, 2010 disclosing a collar that inhibits excessive neck movement during impact, but allows a high degree of movement of the user's head during normal collar operation. May include impact surface (s) that limit the movement of a helmet by contacting the bottom of the helmet; support surface (s) configured to support the user; a structure between the impact surface and the support surface, sufficiently resistant to transfer the impact loads of the helmet to the impact surface, to the body of the user; where the impact surface is displaceable towards an adjacent part of the bearing surface and where the structure is configured to allow displacement at speeds slower than a predetermined displacement speed and to resist displacement if the displacement speed exceeds the default speed. It can include a pivot joint between the movable part and the rest of the collar and the impact brake elements.

However, this collar is adapted to protect a user while wearing a motorcycle helmet, so it would not protect in the same way if the person is not wearing a helmet. In addition, it consists of many elements and is complex, so the assembly requires a longer time and may involve more expenses.

Carlito V. Bugarin document U.S. Pat. No. 6,409,694 was also found which was published on Jun. 25, 2002 which discloses a ventilated neck brace that supports the wearer's neck while providing improved ventilation and breathability. Most collar embodiments include an elongated member defining a neck support, a transition section, and an elongated armrest. Most collar settings allow the user to adjust the width and length of the collar. However, this collar is made of a rigid material so it is not comfortable, and it does not give the necessary support to protect a user from falling if s/he is wearing a harness working at heights.

Document U.S. Pat. No. 6,058,517 by Byron V. Hartunian was also found, which was published on May 9, 2000 disclosing a sports collar for use by players in a contact team sport. The clamp is made of foam and is adapted to hold around the user's neck, thus surrounding the user's neck with 360 degrees. damping. The brace is self-contained and has a generally inverted puckered trunk shape with the part in contact with a user's helmet generally angled up and out from the bottom of the user's helmet.

However, it is configured to be worn by an athlete while wearing a helmet such as football or other contact sport, so it does not optimally cushion when the helmet is gone. In addition, this collar is placed around the neck covering the entire area of this, in the case of a worker at heights, protection in the front area of the neck is not necessary, so it would be unnecessary and would not be comfortable.

As there are no collars adapted for height workers when a lifeline is connected to the front of the harness, avoiding severe injury or death, the present invention was created.

### OBJECT OF THE INVENTION

The main object of the present invention is to make available a safety harness collar for the protection of personnel working at heights, in case of falls, that prevents the whiplash caused by a fall on the worker's head when a lifeline is placed on the front of a harness, avoiding severe injury or death.

Another object of the present invention is to provide said collar for safety harness for the protection of personnel working at heights, in case of fails, that can be connected to any harness.

Another object of the present invention is to make said safety harness collar available for the protection of personnel working at heights, in the event of falls, that is light, comfortable and has the necessary softness so that rubbing against the skin does not generate irritations.

Another object of the present invention is to provide said collar for safety harness for the protection of personnel working at heights, in case of falls, that have sufficient compression resistance generated when suffering a fall with a lifeline connected to a frontal harness.

Another object of the present invention is to make said safety harness collar available for the protection of personnel working at heights, in the event of falls, that resist the friction generated in the different tasks to which it will be subjected.

Another object of the present invention is to provide said collar for safety harness for the protection of personnel working at heights, in case of falls, that is efficient and functional.

And all those qualities and objectives that will become apparent when making a general and detailed description of the present invention supported by the illustrated modalities.

### BRIEF DESCRIPTION OF THE INVENTION

In general, the safety harness collar for the protection of personnel working at heights in the event of falls, in accordance with the present invention, consists of a substantially curved body made up of a plurality of layers of various synthetic or organic materials wound or inlayed, housed in a containment sheath that offer a certain hardness and at the same time a certain flexibility and cushioning, which includes at least two fixing means for attaching to the straps of a harness that pass through the shoulders of a user and cross in the front and rear area of the user, to grasp and dispose around the nape and sides of the neck to offer support and limit the sudden movement of the neck towards the back of the user to avoid damage to the cervical vertebrae and even the death of the user in the case of a fall. The body of the collar comprises rigid materials, but at the same time malleable and in the outer layers soft and cushioned materials to offer optimal support to the user's neck.

In one of the embodiments of the invention, the collar is connected with attachment means to a jacket that surrounds the user's shoulders and extends towards the chest area and towards the back area; wherein said jacket comprises fastening means, preferably belts that hug the straps of a harness that pass through the shoulders of a user and intersect in the front and rear areas of the user.

In order to better understand the characteristics of the invention, the present description is accompanied, as an integral part thereof, by the drawings with illustrative but not limiting character, which are described below.

### BRIEF DESCRIPTION OF FIGURES

FIG. 1 shows a conventional perspective view of the safety harness collar for the protection of personnel working at heights.

FIG. 2 shows a rear view of a harness to Which the safety harness collar is adapted for the protection of personnel working at heights, in accordance with the present invention, being placed on a user and where the harness is connected in its front part to a lifeline.

FIG. 3 shows a rear perspective view of a harness to which the collar for safety harness is adapted for the protection of personnel working at heights, in accordance with the present invention., being placed on a user and where the harness it is connected at its front to a lifeline.

FIG. 4 shows a side view of a harness to which the safety harness collar is adapted for the protection of personnel working at heights, in accordance with the present invention, being placed on a user and where the harness is connected in its front part to a lifeline.

FIG. 5 shows a side perspective view of a harness to which the safety harness collar is adapted for the protection of personnel working at heights, in accordance with the present invention, being placed on a user, where the harness is connected at its front to a lifeline and where the user has suffered a fall.

FIG. 6 shows a rear perspective view of a harness to which the collar for safety harness is adapted for the protection of personnel working at heights, in accordance with the present invention, being placed on a user, where the harness is connected at its front to a lifeline and where the user has suffered a fall.

FIG. 7 shows a side perspective view of a harness to which the safety harness collar is adapted for the protection of personnel working at heights, in accordance with the present invention, being placed on a user, where the harness is connected on its back to a lifeline and where the user has suffered a fall.

For a better understanding of the invention, a detailed description will be made of some of the embodiments thereof, shown in the drawings, which are attached to the present description for illustrative but non-limiting purposes.

### DETAILED DESCRIPTION OF THE INVENTION

The characteristic details of the safety harness collar for the protection of personnel working at heights are clearly shown in the following description and in the accompanying illustrative drawings, the same reference signs serving to indicate the same parts.

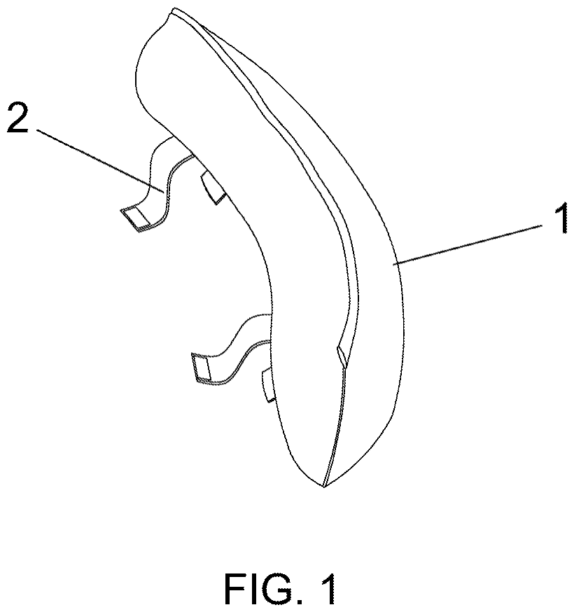

Referring to FIG. 1, the collar (1) for safety harness for the protection of personnel working at heights, in accordance with the present invention, consists of a substantially curved body formed by a plurality of layers of various synthetic or organic materials rolled or inlayed, housed in a containment sheath that offer a certain hardness and at the same time a certain flexibility and cushioning which includes at least two fixing means (2) to be attached to the straps of a harness that pass over the shoulders of a user and intersect at the front and rear of the wearer, to grip and dispose around the nape of the neck and sides of the neck to offer support and limit sudden movement of the neck towards the back of the user to avoid cervical damage and even death of the user in the event of a fall.

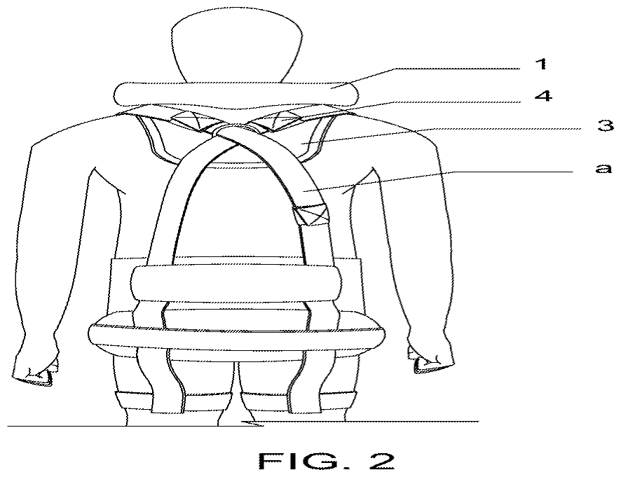

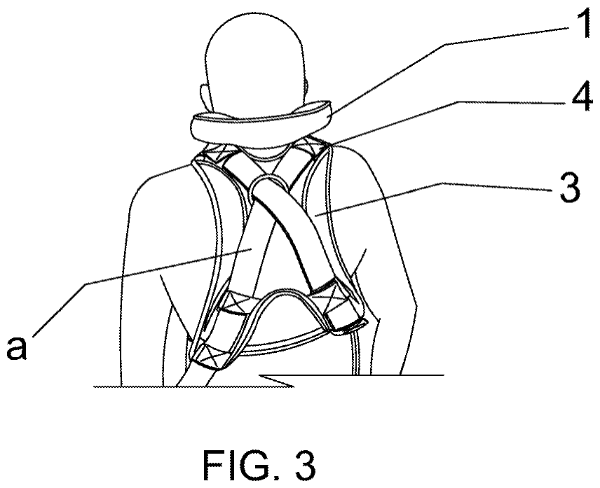

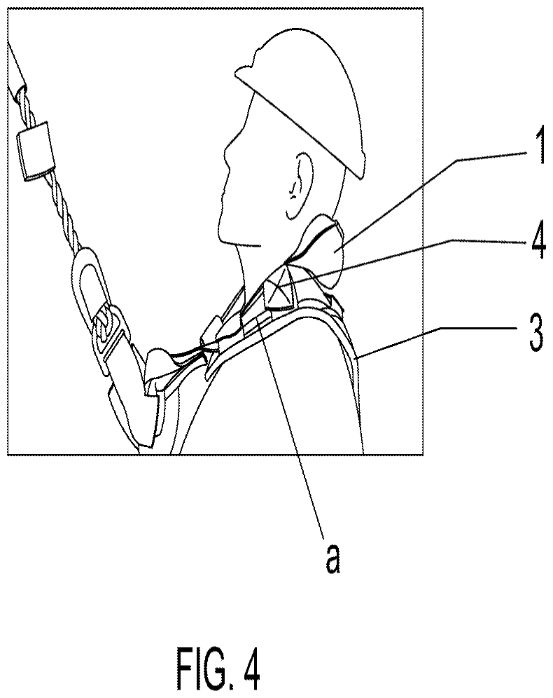

Referring to FIGS. 2 to 7, the collar (1) is attached with attachment means to a jacket (3) that surrounds the user's shoulders and extends towards the chest area and towards the back area; wherein said jacket (3) comprises fixing means (4), preferably belts that embrace the straps of a harness (a) that pass through the shoulders of a user and intersect in the front and rear area of the user; where the harness (a) is connected frontally or at the back to a lifeline.

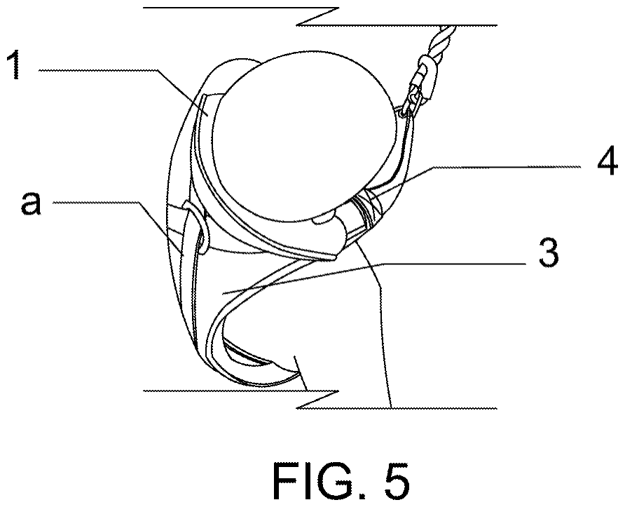

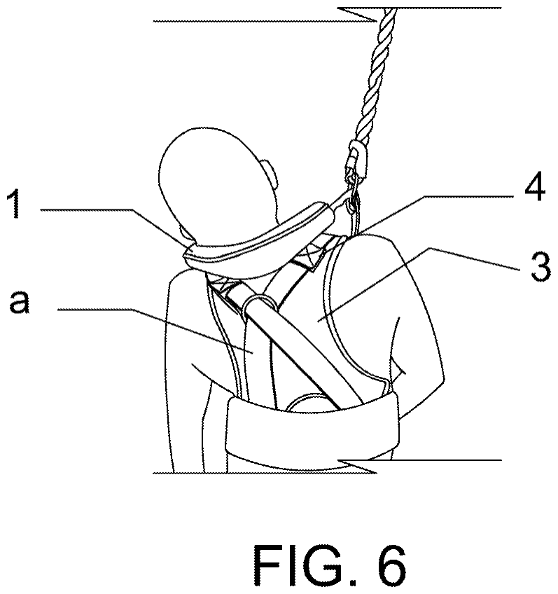

Referring to FIGS. 5 and 6, when a user connected to the lifeline at the front of a harness (a) suffers a fall, the collar (1) offers support in the nape area and the sides of the neck to optimally protect the user, avoiding severe injuries and even death.

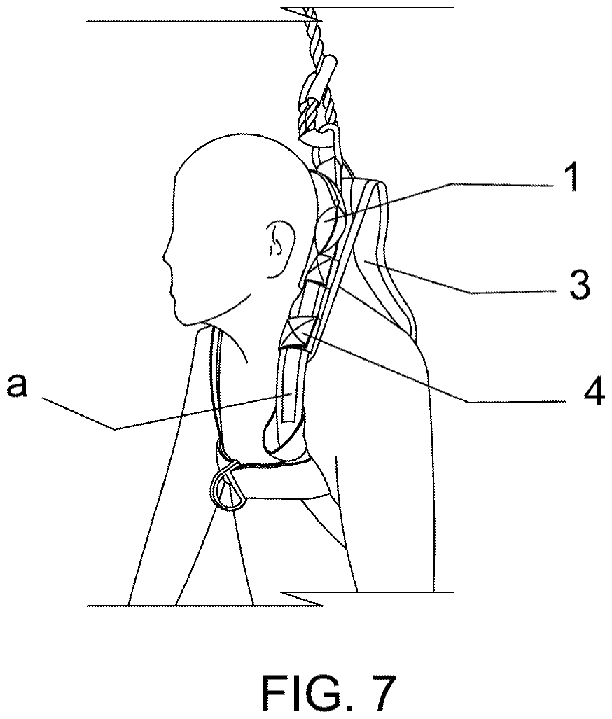

Referring to FIG. 7, when a user connected to the lifeline at the back of a harness (a) suffers a fall, the collar (1) is also necessary, since when suffering the fall, the head is going forward and bouncing backwards with great force, the collar (1) offers support in the nape area and the sides of the neck to optimally protect the user, avoiding severe injuries and even death.

The invention has been sufficiently described so that a person with average knowledge in the matter can reproduce and obtain the results mentioned in the present invention. However, any person skilled in the field of the art that corresponds to the present invention may be able to make modifications not described in the present application, however, if for the application of these modifications in a certain structure or in the manufacturing process thereof, the subject matter claimed in the following claims is required, said structures must be included within the scope of the invention.

1. A safety harness collar for the protection of personnel working at height comprising:
a substantially curved body made up of a plurality of layers of various synthetic or organic materials rolled or inlaid, housed in a containment cover that offers a certain hardness and at the same time a certain flexibility and cushioning which includes at least two fixing means to fix on the straps of a harness that pass through the shoulders of a user and intersect in the front and rear area of the user, to hold on and be arranged around the nape of the neck and sides of the user's neck to offer support and limit the abrupt movement of the neck towards the back of the user that prevents cervical damage and even the death of the user in the event of a fall.

2. The collar for safety harness for the protection of personnel working at heights, according to claim 1, wherein the body comprises rigid, but at the same time malleable materials and in the outer layers soft and cushioned materials to offer optimal support to the user's neck.

3. The collar for safety harness for the protection of personnel working at heights, according to claim 1, wherein it is connected with connecting means to a jacket that surrounds the user's shoulders and extends towards the chest area and towards the back area;
wherein the jacket comprises fastening means, preferably belts that embrace the straps of a harness that pass through the shoulders of a user and intersect in the front and rear areas of the user.
